(19) United States
(12) Patent Application Publication
(10) Pub. No.: US 2009/0190343 A1
(43) Pub. Date: Jul. 30, 2009

(54) INCANDESCENT LAMP APPARATUS AND HEATING APPARATUS

(75) Inventor: Masatoshi Shimonaka, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA, Tokyo (JP)

(21) Appl. No.: 12/357,828

(22) Filed: Jan. 22, 2009

(30) Foreign Application Priority Data
Jan. 24, 2008 (JP) 2008-013325
Oct. 24, 2008 (JP) 2008-274245

(51) Int. Cl. F21V 21/00

(52) U.S. Cl. 362/217.01

(57) ABSTRACT

An incandescence lamp apparatus, comprises two or more incandescence lamps arranged in parallel to each other, each of which has a tube type glass bulb, wherein the glass bulb of each incandescence lamp has an exhaust pipe remaining portion, wherein in a plane perpendicular to a tube axis of the glass bulb, the respective exhaust pipe remaining portions of the two or more incandescence lamps are located within an envelope curve which is commonly in contact with respective outer circumferential surfaces of the glass bulbs of the two or more incandescence lamps, and wherein all of the exhaust pipe remaining portions adjacent to each other respectively overlap each other in a direction in which the incandescence lamps extend.

### CROSS-REFERENCES TO RELATED APPLICATION

This application claims priority from Japanese Patent Application Serial Nos. 2008-13325, filed Jan. 24, 2008, and 2008-274245 filed Oct. 24, 2008, 2008, the contents of which are incorporated herein by reference in their entireties.

### TECHNICAL FIELD

The present invention relates to a heat roller fixing type heating apparatus in an image forming apparatus, such as a copying machine, a laser beam printer or a facsimile, which uses, for example, electro-photography, and relates to an incandescence lamp apparatus, which is arranged in a heating roller which forms such a heating apparatus, and is used as a heating source of the heating roller.

### BACKGROUND

The structure of a heating roller in which incandescence lamps are arranged as a heat source, is conventionally known. Usually, such incandescence lamps are arranged, corresponding to the sizes of paper sheets, such as A4 and B4, that is, areas of the heating roller, through which the paper passes. Or, two or more incandescence lamps are usually arranged in parallel to each other in the heating roller, in order to increase an optical output when raising the surface temperature of a heating roller to a predetermined temperature for a short time after it is turned on.

FIG. 7 is an explanatory perspective view of the structure of such a conventional incandescence lamp apparatus arranged in a heating roller. FIG. 8 is an explanatory side elevational view of the incandescence lamps shown in FIG. 7, which is viewed in a longitudinal direction of the incandescence lamp apparatus, wherein the arrangement of the incandescence lamps is shown. In addition, in FIG. 8, sealing portions and bases thereof are omitted from the drawing, so that the physical relationship of glass bulbs and remaining portions of exhaust pipes may be seen.

The conventional incandescence lamp apparatus has three incandescence lamps. Each of the incandescence lamps A, B and C has a pipe shaped glass bulb 2, in which a filament 1 is arranged. These three incandescence lamps are arranged so as to be in parallel to one another. Each incandescence lamp is fixed with the bases 3 at both ends thereof.

Exhaust pipe remaining portions 2a, 2b, and 2c project from the respective outer circumferential surfaces of the glass bulbs 2 of the incandescence lamps A, B, and C. The filaments suitable for the incandescence lamps A, B, and C are respectively inserted so that the heating patterns of the filaments arranged inside the incandescence lamps A, B, and C may differ from one another. However, in order to simplify a lamp manufacturing process, the shape of the glass bulb 2 of each incandescence lamp or the attachment position of an exhaust pipe which becomes each of the exhaust pipe remaining portions 2a, 2b, and 2c is the same as one another. Therefore, in the incandescence lamps A, B, and C, the exhaust pipe remaining portions 2a, 2b, and 2c are formed in the same position in a direction in which the glass bulbs 2 extend.

Consequently, all the exhaust pipe remaining portions 2a, 2b, and 2c are directed outward with respect to a virtual center line O drawn in the longitudinal direction of the incandescence lamp apparatus, so that the exhaust pipe remaining portions 2a, 2b, and 2c of the respective incandescence lamps A, B, and C do not interfere with and are not in contact with one another.

In such an incandescence lamp apparatus, in a plane perpendicular to the tube axis of the glass bulb as shown in FIG. 8, three external tangents L common to the glass bulbs of the incandescence lamps adjacent to each other are respectively drawn. Contacts of the external tangents L of the respective glass bulbs 2 are referred to as a1, a2, b1, b2, c1, and c2. Moreover, an outer circumferential surface of the incandescence lamp A between the contacts a1 and a2, which does not face the other glass bulbs, is referred to as a contour (line) LA, an outer circumferential surface of the incandescence lamp B between the contacts b1 and b2, which does not face the other glass bulbs, is referred to as a contour (line) LB, and an outer circumferential surface of the incandescence lamp C between the contacts c1 and c2, which does not face the other glass bulbs, is referred to as a contour (line) LC. And a line formed by connecting the three external tangents L and the contours LA, LB, and LC, is an envelope curve which becomes a lamp outline in contact with the respective outer circumferential surfaces of all the incandescence lamps A, B, and C. The exhaust pipe remaining portions 2a, 2b, and 2c project outward from this envelope curve.

That is, the exhaust pipe remaining portion 2a projects outward from the outline line LA, the exhaust pipe remaining portion 2b is also projected outward from the outline line LB, and the exhaust pipe remaining portion 2c projects from the external tangent L. Consequently, when such an incandescence lamp apparatus is inserted into a heating roller, since there is a clearance (space) between an inner side of the heating roller and the incandescence lamp apparatus, when the incandescence lamp is inserted in the heating roller while the incandescence lamp apparatus inclines, there is a possibility that part of the exhaust pipe remaining portions 2a, 2b, and/or 2c may hit an opening edge of the heating roller, resulting in damage of an incandescence lamps. See Japanese Laid Open Patent No. 20005-216734 for such an incandescence lamp apparatus.

### SUMMARY

In view of the problem of the above-mentioned prior art, it is an object of the present invention to offer an incandescence lamp apparatus in which two or more incandescence lamps are arranged in parallel to one another, and in which they are not damaged when the incandescence lamp apparatus is inserted into a heating roller. In addition, it is an object to offer an incandescence lamp apparatus in which the entire shape does not become large. Furthermore, it is an object of the present invention to offer a heating apparatus wherein such a incandescence lamp apparatus is arranged in a heating roller.

One of aspects of the present invention is that an incandescence lamp apparatus comprises two or more incandescence lamps arranged in parallel to each other, each of which has a tube type glass bulb, wherein the glass bulb of each incandescence lamp has an exhaust pipe remaining portion, wherein in a plane perpendicular to a tube axis of the glass bulb, the respective exhaust pipe remaining portions of the two or more incandescence lamps are located within an envelope curve which is commonly in contact with respective outer circumferential surfaces of the glass bulbs of the two or more incandescence lamps, and wherein all of the exhaust pipe remaining portions adjacent to each other respectively overlap each other in a direction in which the incandescence lamps extend.

Another aspect of the present invention is that a heating apparatus, comprises the above mentioned incandescence lamp apparatus, and a heating roller, wherein the heating roller is arranged in the heating roller.

In the incandescence lamp apparatus or the heating apparatus, the glass bulbs of the incandescence lamps which are adjacent to each other may be in contact with each other, and the exhaust pipe remaining portion of each incandescence lamp may be located in a virtual closed space surrounded by the glass bulbs of the incandescence lamps.

In the incandescence lamp apparatus or the heating apparatus, the exhaust pipe remaining portions may be formed on the respective outer circumferential surfaces of the glass bulbs at positions different from each other in a direction in which the incandescence lamps extend.

In the incandescence lamp apparatus, or the heating apparatus, the exhaust pipe remaining portions may be formed on the respective outer circumferential surfaces of the glass bulbs at the same position in a direction in which the incandescence lamps extend, and a distance between the two of the incandescence lamps may be greater than a total of heights of the respective exhaust pipe remaining portions of the two or more incandescence lamps.

In the present incandescence lamp apparatus, in which three or more incandescence lamps respectively having a tubular glass bulb, are arranged in parallel to one another, since, on a plane perpendicular to the tube axes of the glass bulbs, an exhaust pipe remaining portion of each incandescence lamp is located within the envelope curve which is in contact with the respective outer circumferential surfaces of the glass bulbs of the two or more incandescence lamps, the exhaust pipe remaining portions do not hit an opening edge of a heating roller when the incandescence lamp apparatus is inserted into the heating roller, so that the incandescence lamps are not damaged. Furthermore, since all the exhaust pipe remaining portions adjacent to each other are overlapped in a direction in which the incandescence lamps extend, the exhaust pipe remaining portions do not interfere with one another, so that incandescence lamps can be brought close to one another, whereby the size of the entire incandescence lamp apparatus does not become large.

Furthermore, the glass bulbs of the incandescence lamps adjacent to each other, are in contact with each other, and the exhaust pipe remaining portion of each incandescence lamp is located, inside the virtual closed space surrounded by the glass bulbs of the respective incandescence lamps, so that the size of the entire incandescence lamp apparatus can be made small.

In the incandescence lamp apparatus, the two or more incandescence lamps, each of which has a tubular glass bulb, are arranged in parallel to one another, and since the incandescence lamp apparatus in which the exhaust pipe remaining portion of each incandescence lamp is located in an inner direction of the envelope curve which is commonly in contact with the outer circumferential surfaces of the glass bulbs of two or more incandescence lamps in a plane perpendicular to the tube axes of the glass bulbs, is arranged inside the heating roller, it is possible to make the outer diameter of the heating roller small, so that the size of the entire heating apparatus can be made small.

### BRIEF DESCRIPTION OF DRAWINGS

Other features and advantages of the present incandescence lamp apparatus and the heating apparatus will be apparent from the ensuing description, taken in conjunction with the accompanying drawings, in which:

FIG. 1 is an explanatory perspective view showing the structure of an incandescence lamp apparatus according to the present invention;

FIG. 2 is an explanatory side elevational view of incandescence lamps shown in FIG. 1, which are viewed in a longitudinal direction of the incandescence lamp apparatus, wherein the arrangement of the incandescence lamps is shown;

FIG. 3 is an explanatory side elevational view of another embodiment of an incandescence lamp apparatus according to the present invention, which is viewed from a longitudinal direction of the incandescence lamp apparatus wherein the arrangement of incandescence lamps is shown;

FIG. 4 is an explanatory side elevational view of still another embodiment of an incandescence lamp apparatus according to the present invention, which is viewed from a longitudinal direction of the incandescence lamp apparatus, wherein the arrangement of incandescence lamps is shown;

FIG. 5 is an explanatory side elevational view of still another embodiment of an incandescence lamp apparatus according to the present invention, which is viewed from a longitudinal direction of the incandescence lamp apparatus, wherein the arrangement of incandescence lamps is shown;

FIG. 6 is an explanatory cross-sectional view of a heating apparatus according to the present invention in which the incandescence lamp apparatus shown in FIG. 1 is arranged in a heating roller;

FIG. 7 is an explanatory perspective view of the structure of such a conventional incandescence lamp apparatus arranged in a heating roller; and

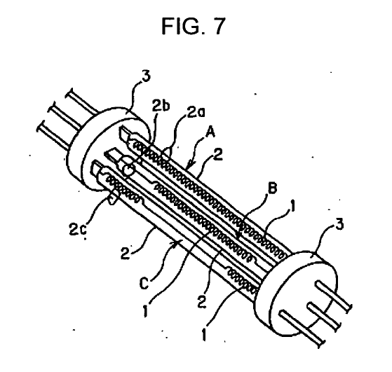

FIG. 8 is an explanatory side elevational view of the incandescence lamps shown in FIG. 7, which is viewed in a longitudinal direction of an incandescence lamp apparatus, wherein the arrangement of the incandescence lamps is shown.

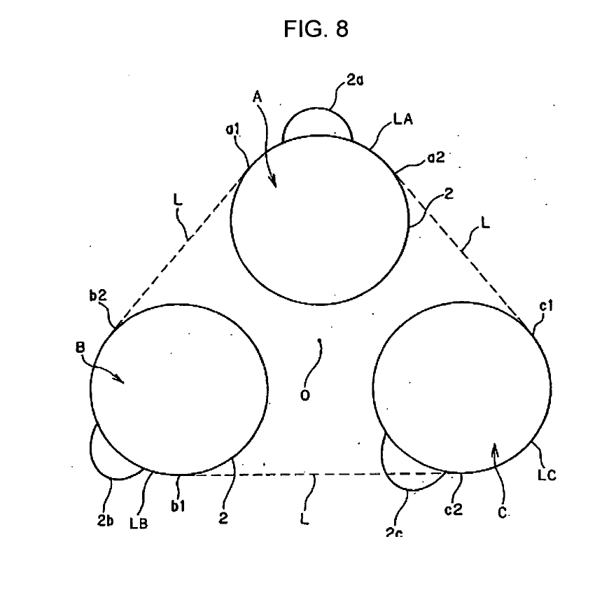

### DETAILED DESCRIPTION

A description of embodiments of the present incandescence lamp apparatus and the heating apparatus will now be given below, referring to drawings. While the claims are not limited to such embodiments, an appreciation of various aspects of the present incandescence lamp apparatus and the heating apparatus are best gained through a discussion of various examples thereof.

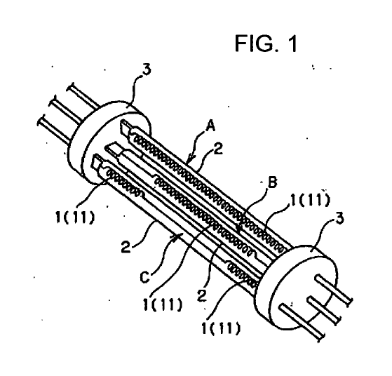

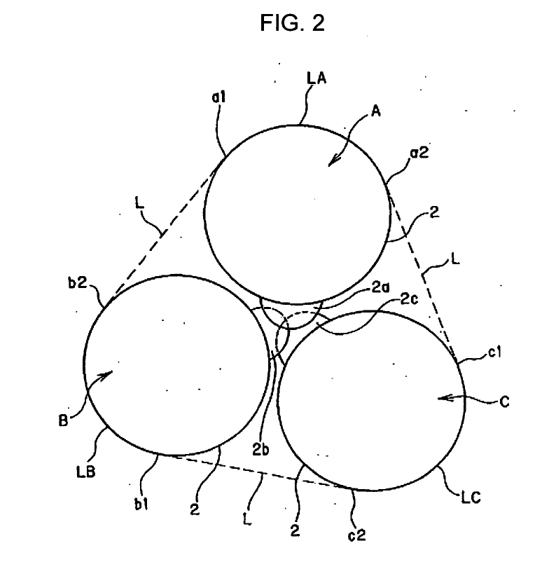

FIG. 1 is an explanatory perspective view showing the structure of an incandescence lamp apparatus according to the present invention. FIG. 2 is an explanatory side elevational view of the present incandescence lamps shown in FIG. 1, which is viewed in a longitudinal direction of the incandescence lamp apparatus, wherein the arrangement of the incandescence lamps is shown. In addition, in FIG. 2, sealing portions and bases thereof are omitted from the drawing, so that the physical relationship between glass bulbs and remaining portion of exhaust pipe (hereinafter referred to as exhaust pipe remaining portions) may be seen.

In the incandescence lamp apparatus, three incandescence lamps A, B and C are provided in parallel to one another, where each of the lamps has a diameter of 6 mm, and each lamp has a pipe shape glass bulb 2 in which a filament 1 is arranged. Both sides of each incandescence lamp are respectively fixed to the bases 3.

The incandescence lamps A, B, and C respectively have a heating pattern (heating area), wherein these patterns are different from one another. A light emission section 11 of the filament 1 provided in the incandescence lamp A, is formed throughout the glass bulb 2 in the longitudinal direction of the glass bulb 2. A light emission section 11 of the filament 1 provided in the incandescence lamp B is formed in a central area in the longitudinal direction of the glass bulb 2. A light emission sections 11 of the filament 1 of the incandescence lamp C are formed in areas at the both ends in the longitudinal direction of the glass bulb 2. The light emission section 11 of the filament 1 of the incandescence lamp B and that of the incandescence lamp C are formed so as not to overlap each other.

In this example of the incandescence lamp apparatus, a line which passes through the center of the glass bulb 2 in the longitudinal direction is a reference line which is matched with the center of a paper sheet passing through a heating roller. Based on the line which passes through the center of the glass bulb 2, for example, in case an A4 size paper sheet which is small in width is heated, the incandescence lamp B is turned on. In addition, in case that a B4 size paper sheet which is larger in width than the A4 size paper sheet is heated, both the incandescence lamps B and C are turned on. Moreover, an optical output of the incandescence lamp A is larger than that of the incandescence lamp B or C, and is an auxiliary lamp which is turned on with a large output, in order to make the surface temperature of the heating roller reach a predetermined temperature for a short time after an image forming machine is turned on.

As shown in FIG. 2, the exhaust pipe remaining portions 2a, 2b, and 2c are formed, so as to project from the respective outer circumferential surfaces of the glass bulbs 2 of the incandescence lamps A, B, and C. An external tangent L common to the glass bulbs 2 of the incandescence lamps which are adjacent to each other is hypothetically drawn, respectively. Also, external tangents L are hypothetically drawn for the other incandescence lamps. In FIG. 2, the three external tangents L are hypothetically drawn, and the contacts formed by the external tangents L in the respective glass bulbs 2 are referred to as a1, a2, b1, b2, c1, and c2.

An outer circumferential surface of the glass bulb 2 of the incandescence lamp A, which is located between the contacts a1 and a2 formed by different external tangents L and which does not face the glass bulbs 2 of the other incandescence lamps B and C, is referred to as a contour (line) LA. In the same way, an outer circumferential surface of the glass bulb 2 of the incandescence lamp B, which is located between the contacts b1 and b2 formed by different external tangents L and which does not face the other glass bulbs 2 of the other incandescence lamps A and C, is referred to as a contour (line) LB. Moreover, an outer circumferential surface of the glass bulb 2 of the incandescence lamp C, which is located between the contacts c1 and c2 formed by different external tangents L and which does not face the other glass bulbs 2 of the other incandescence is referred to as a contour (line) LC. And a line formed by connecting the three external tangents L and the contours LA, LB, and LC, is an envelope curve which becomes a lamp outline and which is commonly in contact with the respective outer circumferential surfaces of all the incandescence lamps A, B, and C. The exhaust pipe remaining portions 2a, 2b, and 2c project inward from this envelope curve.

Furthermore, the exhaust pipe remaining portions 2a, 2b, and 2c are respectively formed on the outer circumferential surfaces of the glass bulbs 2 at different positions in a direction the incandescence lamps extend. Moreover, the exhaust pipe remaining portions (2a, 2b, and 2c) adjacent to each other, overlap each other in a direction in which these incandescence lamps extend. In FIG. 2, all the exhaust pipe remaining portions 2a, 2b, and 2c, overlap one another in the direction these incandescence lamps extend.

Consequently, all the exhaust pipe remaining portions 2a, 2b, and 2c, are located within the envelope curve which is the lamp outline formed by connecting the three external tangents L and the contours LA, LB, and LC. Since they do not project outside the envelope curve, when the incandescence lamp apparatus is inserted into the heating roller, the exhaust pipe remaining portions 2a, 2b, and 2c do not hit the opening edge of the heating roller, so that the incandescence lamps are not damaged.

Furthermore, the exhaust pipe remaining portions 2a, 2b, and 2c which are adjacent to each other, overlap each other in the direction in which the incandescence lamps extend, so that the exhaust pipe remaining portions 2a, 2b, and 2c do not get into touch with each other, whereby the incandescence lamps can be brought close. While all the exhaust pipe remaining portions 2a, 2b, and 2c are located inside the envelope curve, the shape in a cross-sectional view of the incandescence lamp apparatus, taken along a plane perpendicular to the tube axis of the glass bulbs can be prevented from becoming large. That is, the size of the entire incandescence lamp apparatus does not become large.

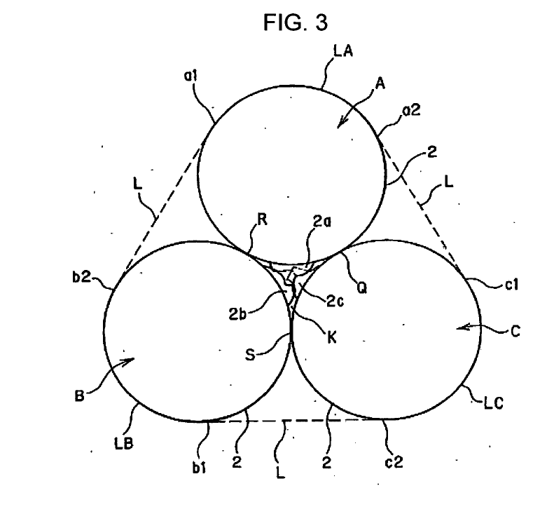

FIG. 3 is an explanatory side elevational view of another embodiment of an incandescence lamp apparatus according to the present invention, which is viewed from a longitudinal direction of the incandescence lamp apparatus wherein the arrangement of the incandescence lamp is shown. In FIG. 3, sealing portions and bases thereof are omitted from the drawing, so that the physical relationship of glass bulbs and exhaust pipe remaining portions may be seen. The same reference numerals as those shown in FIG. 2 are assigned to the same elements in FIG. 3, and explanation thereof is omitted.

The incandescence lamp apparatus shown in FIG. 3 differs from the incandescence lamp apparatus shown in FIG. 2, in that the glass bulbs 2 of the incandescence lamps A, B, and C which are adjacent to each other, get into touch with each other. All the exhaust pipe remaining portions 2a, 2b, and 2c of the incandescence lamps A, B, and C are located in a virtual closed space K surrounded by the glass bulbs 2 of the incandescence lamps A, B, and C. The virtual closed space is a space inside the (internal) outline of the incandescence lamps, which is formed by connecting the respective contacts Q, R, and S of the glass bulbs 2 of the incandescence lamps adjacent to each other on a plane, along contours which are part of the outer circumferential surfaces of the glass bulbs 2.

All the exhaust pipe remaining portions 2a, 2b, and 2c of the incandescence lamps A, B, and C are shaped by a paddle etc. after the respective exhaust pipes are chipped off and while the exhaust pipe remaining portions are softened with heat, so that they are located inside the virtual closed space K.

Consequently, since all the exhaust pipe remaining portions 2a, 2b, and 2c do not interfere with one another, the incandescence lamps can be fit in the virtual closed space, so that the glass bulbs 2 of the incandescence lamps which are adjacent to each other can be brought into contact with each other, whereby the shape of the incandescence lamp apparatus in a cross-sectional view thereof taken along a plane perpendicular to the tube axis of the glass bulbs can be made small. That is, the size of the entire incandescence lamp apparatus can be miniaturized.

In recent years, it is necessary to decrease the heat capacity of the heating roller, in order to make the surface temperature of the heating roller reach a predetermined temperature for a short time after an image forming machine is turned on. Specifically, the roller diameter of such a heating roller is made small, and thus, miniaturization of the heating roller is in progress. However, the incandescence lamp apparatus shown in FIG. 3, can be certainly inserted into such a miniaturized heating roller.

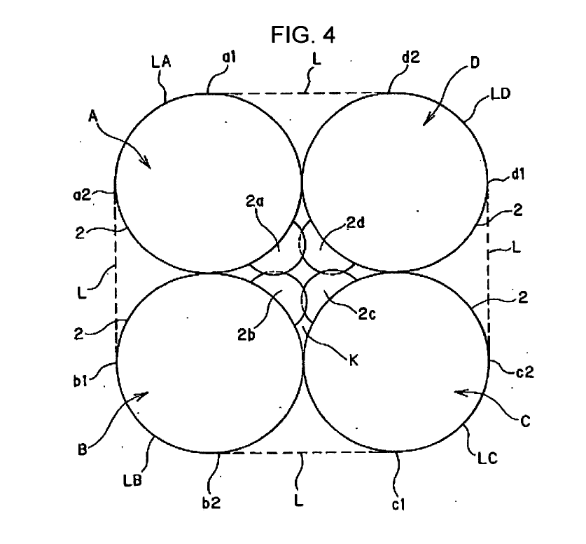

FIG. 4 is an explanatory side elevational view of still another embodiment of an incandescence lamp apparatus according to the present invention, which is viewed from a longitudinal direction of the incandescence lamp apparatus, wherein the arrangement of incandescence lamp is shown. In FIG. 4, sealing portions and bases thereof are omitted from the drawing, so that the physical relationship of glass bulbs and exhaust pipe remaining portions may be seen. In FIG. 4, the same reference numerals as those shown in FIG. 2 are assigned to the same elements as those shown in FIG. 2, and explanation thereof is omitted.

The incandescence lamp apparatus shown in FIG. 4 differs from the incandescence lamp apparatus shown in FIG. 2 in that four incandescence lamps are used. In FIG. 4, the four external tangents L which are respectively common to the glass bulbs 2 of incandescence lamps adjacent to each other are hypothetically drawn, and contacts formed by the external tangents L on the glass bulbs 2 of the incandescence lamps are referred to as a1, a2, b1, b2, c1, c2, d1 and d2.

An outer circumferential surface of the glass bulb 2 of the incandescence lamp A, which is located between the contacts a1 and a2 formed by different external tangents L and which does not face the glass bulbs 2 of the other incandescence lamps B, C and D, is referred to as a contour (line) LA. In the same way, an outer circumferential surface of the glass bulb 2 of the incandescence lamp B, which is located between the contacts b1 and b2 formed by different external tangents L and which does not face the other glass bulbs 2 of the other incandescence lamps A, C and D, is referred to as a contour (line) LB. Moreover, an outer circumferential surface of the glass bulb 2 of the incandescence lamp C, which is located between the contacts c1 and c2 formed by different external tangents L and which does not face the other glass bulbs 2 of the other incandescence lamps A, B and D is referred to as a contour (line) LC. Moreover, an outer circumferential surface of the glass bulb 2 of the incandescence lamp D, which is located between the contacts d1 and d2 formed by different external tangents L and which does not face the other glass bulbs 2 of the other incandescence lamps A, B and C is referred to as a contour (line) LD. And a line formed by connecting the four external tangents L and the contours LA, LB, LC and LD is an envelope curve which becomes a lamp outline and which is commonly in contact with the respective outer circumferential surfaces of all the incandescence lamps A, B, C and D. All the exhaust pipe remaining portions 2a, 2b, 2c and 2d are located inside this envelope curve. Furthermore, the exhaust pipe remaining portions 2a, 2b, 2c, and 2d, adjacent to each other overlap each other in a direction in which the incandescence lamps extend.

Description of the overlapped exhaust pipe remaining portions will be given below. Exhaust pipe remaining portions adjacent to the exhaust pipe remaining portion 2a of the incandescence lamp A are the exhaust pipe remaining portion 2b of the incandescence lamp B, and the exhaust pipe remaining portion 2d of the incandescence lamp D. The exhaust pipe remaining portion 2a overlaps both the exhaust pipe remaining portions 2b and 2d in a direction the incandescence lamps extend. Although description about the incandescence lamps B, C, and D is omitted, similarly to the case of the incandescence lamp A, in case of the incandescence lamps B, C and D, the exhaust pipe remaining portions which are adjacent to each other overlap each other in the direction in which the incandescence lamps extend.

The exhaust pipe remaining portions 2a, 2b, 2c, and 2d are respectively formed in different positions in the direction in which the incandescence lamps extend, so that the exhaust pipe remaining portion 2a, 2b, and 2c and 2d do not get into touch with one another, so as not to interfere with one another. However, the exhaust pipe remaining portions which are not adjacent to each other, for example, the exhaust pipe remaining portion 2a and the exhaust pipe remaining portion 2c, do not get touch with each other so as not to interfere each other, if a distance between the incandescence lamp A and the incandescence lamp C is more than the total of the heights of the exhaust pipe remaining portions, even though the exhaust pipe remaining portions are formed in the same position in the direction in which the incandescence lamps extend,

Consequently, all the exhaust pipe remaining portions 2a, 2b, 2c and 2d are located inside the envelope curve which becomes a lamp outline and which is commonly in contact with the respective outer circumferential surfaces of all the incandescence lamps A, B, C and D, so that they do not project outward from the envelope line, whereby when the incandescence lamp apparatus is inserted into a heating roller, even if the incandescence lamp apparatus inclines when inserted, since the exhaust pipe remaining portions 2a, 2b, 2c, and 2d do not hit an opening edge of the heating roller, the incandescence lamp is not damaged. Furthermore, since the adjacent exhaust pipe remaining portions 2a, 2b, 2c, and 2d overlap with one another in the direction in which the incandescence lamps extend, the incandescence lamps can be brought close so that the size of the entire incandescence lamp apparatus shape does not become large, while the exhaust pipe remaining portion 2a, 2b, 2c, and 2d do not interfere with one another.

Furthermore, since in the incandescence lamp apparatus shown in FIG. 4, the glass bulbs 2 of the incandescence lamps A, B, C, and D respectively are in contact with the adjacent glass bulbs 2, and all the exhaust pipe remaining portions 2a, 2b, 2c, and 2d are located inside the virtual closed space K surrounded by the glass bulbs 2 of the incandescence lamps A, B, C, and D. Thus, the adjacent glass bulbs 2 of the incandescence lamps are brought into contact with each other, so that the size of the entire incandescence lamp apparatus can be miniaturized.

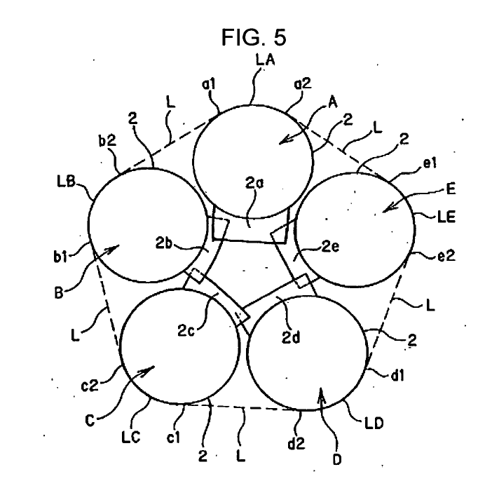

FIG. 5 is an explanatory side elevational view of still another embodiment of an incandescence lamp apparatus according to the present invention, which is viewed from a longitudinal direction of the incandescence lamp apparatus, wherein the arrangement of the incandescence lamp is shown. In FIG. 5, sealing portions and bases thereof are omitted from the drawing, so that the physical relationship of glass bulbs and exhaust pipe remaining portions may be seen. In addition, in FIG. 5, the same reference numerals as those shown in FIG. 2 are assigned to the same elements as those shown in FIG. 2, and explanation thereof is omitted.

The incandescence lamp apparatus shown in FIG. 5 differs from the incandescence lamp apparatus shown in FIG. 2 in that five incandescence lamps A-E are used. In FIG. 5, the five external tangents L which are common to the glass bulbs 2 of incandescence lamps adjacent to each other are hypothetically drawn. As described above, part of an outer circumferential face of each glass bulb 2 is defined as, LA, LB, LC, LD and LE. And a line formed by connecting the five external tangents L and the contours LA, LB, LC, LD and LE is an envelope curve which becomes a lamp outline and which is commonly in contact with the respective outer circumferential surfaces of all the incandescence lamps A, B, C, D and E. All the exhaust pipe remaining portions 2a, 2b, 2c, 2d and 2e are located inside this envelope curve. Furthermore, the exhaust pipe remaining portions 2a, 2b, 2c, 2d, and 2e adjacent to each other respectively overlap each other in a direction in which the incandescence lamps extend. Consequently, when the incandescence lamp apparatus is inserted into a heating roller, even if the incandescence lamp apparatus inclines, the exhaust pipe remaining portions 2a-2e do not hit an opening edge of the heating roller, so that the incandescence lamp is not damaged. Furthermore, the exhaust pipe remaining portions 2a-2e do not interfere with each other, so that the incandescence lamps can be brought close whereby the size of the incandescence lamp apparatus does not become large. In addition, although the glass bulbs 2 of the incandescence lamps which are adjacent to each other are not brought into contact with each other in FIG. 5, if the glass bulbs 2 of the incandescence lamps which are adjacent to each other may be brought into contact with each other by making the shape of the exhaust pipe remaining portions small, the size of the incandescence lamp apparatus can be made much smaller.

In addition, although a drawing does not show a case of an incandescence lamp apparatus having six or more incandescence lamps, if the incandescence lamp apparatus has the similar structure to the above embodiments according to the present invention, similar effects can be obtained.

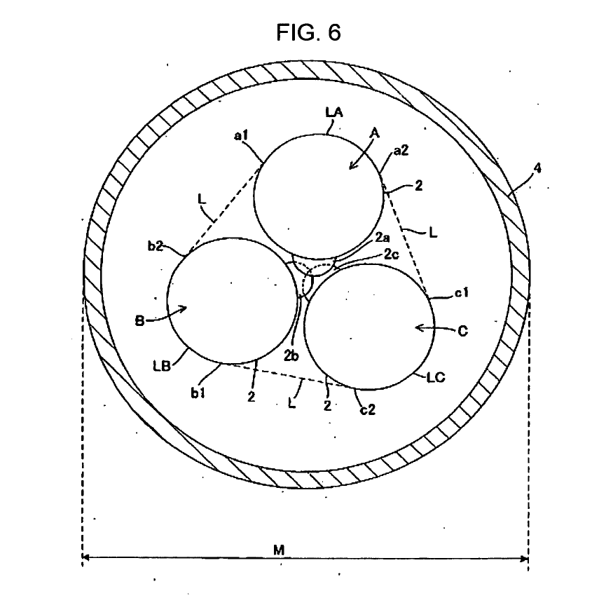

FIG. 6 is an explanatory cross-sectional view of a heating apparatus according to the present invention in which the incandescence lamp apparatus shown in FIG. 1 is arranged in a heating roller. In this explanatory cross-sectional view, the incandescence lamp apparatus is viewed from a longitudinal direction of the incandescence lamp apparatus, wherein the arrangement of the incandescence lamps is shown. The view of the incandescence lamps shown in this figure is a cross sectional view thereof, but it is drawn so that the contour thereof can be seen. In FIG. 6, the view of heating roller is a cross-sectional view.

In FIG. 6, the incandescence lamp apparatus shown in FIG. 1, is arranged in a circle-like heating roller 4 in cross-sectional view thereof. That is, since the shape of the entire incandescence lamp apparatus provided in the heating roller can be made small, the roller diameter M of the heating roller can be made small, and the heat capacity of the heating roller can be made small. It is possible to raise the surface temperature of the heating roller to a predetermined temperature for a short time after an image forming apparatus is turned on.

The preceding description has been presented only to illustrate and describe exemplary embodiments of the present incandescence lamp apparatus and the present heating apparatus according to the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. An incandescence lamp apparatus, comprising:
two or more incandescence lamps arranged in parallel to each other, each of which has a tube type glass bulb,
wherein the glass bulb of each incandescence lamp has an exhaust pipe remaining portion,
wherein in a plane perpendicular to a tube axis of the glass bulb, the respective exhaust pipe remaining portions of the two or more incandescence lamps are located within an envelope curve which is commonly in contact with respective outer circumferential surfaces of the glass bulbs of the two or more incandescence lamps, and
wherein all of the exhaust pipe remaining portions adjacent to each other respectively overlap each other in a direction in which the incandescence lamps extend.

2. The incandescence lamp apparatus according to claim 1, wherein the glass bulbs of the incandescence lamps which are adjacent to each other are in contact with each other, and the exhaust pipe remaining portion of each incandescence lamp is located in a virtual closed space surrounded by the glass bulbs of the incandescence lamps.

3. The incandescence lamp apparatus according to claim 1, wherein the exhaust pipe remaining portions are formed on the respective outer circumferential surfaces of the glass bulbs at positions different from each other in a direction in which the incandescence lamps extend.

4. The incandescence lamp apparatus according to claim 1, wherein the exhaust pipe remaining portions are formed on the respective outer circumferential surfaces of the glass bulbs at the same position in a direction in which the incandescence lamps extend, and a distance between the two of the incandescence lamps is greater than a total of heights of the respective exhaust pipe remaining portions of the two or more incandescence lamps.

5. A heating apparatus, comprising:
the incandescence lamp apparatus according to claim 1; and
a heating roller,
wherein the heating roller is arranged in the heating roller.

6. The incandescence lamp apparatus according to claim 5, wherein the glass bulbs of the incandescence lamps which are adjacent to each other are in contact with each other, and the exhaust pipe remaining portion of each incandescence lamp is located in a virtual closed space surrounded by the glass bulbs of the incandescence lamps.

7. The incandescence lamp apparatus according to claim 5, wherein the exhaust pipe remaining portions are formed on the respective outer circumferential surfaces of the glass bulbs at positions different from each other in a direction in which the incandescence lamps extend.

8. The incandescence lamp apparatus according to claim 5, wherein the exhaust pipe remaining portions are formed on the respective outer circumferential surfaces of the glass bulbs at the same position in a direction in which the incandescence lamps extend, and a distance between the two of the incandescence lamps is greater than a total of heights of the respective exhaust pipe remaining portions of the two or more incandescence lamps.
